(19) United States
(12) Patent Application Publication
(10) Pub. No.: US 2014/0214211 A1
(43) Pub. Date: Jul. 31, 2014

(54) OUTPUTACTUATOR NODE, MPEG TERMINAL WITH OUTPUTACTUATOR NODE, AND METHOD FOR CONTROLLING ACTUATOR USING THE OUTPUTACTUATOR NODE

(71) Applicants: Bum-Suk CHOI, Daejeon-si (KR); Soon-Choul KIM, Daejeon-si (KR); Jeoung-Lak HA, Daejeon-si (KR); Jung-Hak KIM, Daejeon-si (KR); Young-Ho JEONG, Daejeon-si (KR); Jin-Woo HONG, Daejeon-si (KR)

(72) Inventors: Bum-Suk CHOI, Daejeon-si (KR); Soon-Choul KIM, Daejeon-si (KR); Jeoung-Lak HA, Daejeon-si (KR); Jung-Hak KIM, Daejeon-si (KR); Young-Ho JEONG, Daejeon-si (KR); Jin-Woo HONG, Daejeon-si (KR)

(73) Assignee: Electronics and Telecommunications Research Institute, Daejeon-si (KR)

(21) Appl. No.: 14/167,127

(22) Filed: Jan. 29, 2014

(30) Foreign Application Priority Data
Jan. 29, 2013 (KR) 10-2013-0010058
Aug. 12, 2013 (KR) 10-2013-0095652

(51) Int. Cl. G05B 15/02

(52) U.S. Cl. CPC G05B 15/02
USPC 700/275

(57) ABSTRACT

An OutputActuator node, a Moving Picture Experts Group (MPEG) terminal, and a method for controlling an actuator using the OutputActuator node. The OutputActuator node includes an enabled field indicating whether the OutputActuator node is activated or not; a url field designating an actuator to which a command is delivered for control of the actuator; and an eventName field containing a command list for operating the designated actuator.

### CROSS-REFERENCE TO RELATED APPLICATIONS

This application claims the benefit under 35 U.S.C. §119(a) of Korean Patent Applications No. 10-2013-0010058, filed on Jan. 29, 2013, and 10-2013-0095652, filed on Aug. 12, 2013, in the Korean Intellectual Property Office, the entire disclosures of which are incorporated herein by references for all purposes.

### BACKGROUND

1. Field

The following description relates to an augmented reality (AR) technology.

2. Description of Related Art

Augmented broadcasting, as an augmented reality (AR) service, is one example of an enhanced broadcasting service that provides viewers with a vivid sense of reality while smoothly blending augmented content into the broadcast content, unlike traditional digital TV broadcasting services that are transmitted to the viewers from broadcasting service providers in a unidirectional manner. For augmented broadcasting, a receiver terminal, such as a digital TV or a mobile device, may need to set a particular area as an augmentation region in a scene of a broadcast program, and obtain an augmented content for the augmented broadcast program. The broadcasting service provider transmits a broadcast program and the relevant augmentation region information to the receiver terminal. The receiver terminal uses the transmitted augmentation region information to obtain augmented content associated with an augmentation channel selected by the viewer, and outputs the obtained augmented content on the augmentation region.

An AR service is generally an overlay of augmented content on an image captured by a camera equipped in a receiver terminal. For example, when a user runs an AR application and activates a camera in a mobile device in order to find out the location of a destination, the mobile device identifies the user's current location and direction based on data obtained from a global positioning system (GPS) sensor, a compass sensor, a gyro sensor, or the like, and displays the direction of the destination on an image captured by the camera. However, the general AR service simply provides an overlay of augmented content on a screen, and allows only a limited interaction between the augmented content and a user.

### SUMMARY

The following description relates to an OutputActuator node which is capable of providing a realistic augmented reality (AR) service through an interaction between an augmented object and a user, a Moving Picture Experts Group (MPEG) terminal with the OutputActuator node, and a method for controlling an actuator using the OutputActuator node.

In one general aspect, there is provided an OutputActuator node including: an enabled field indicating whether the OutputActuator node is activated or not; a url field designating an actuator to which a command is delivered for control of the actuator; and an eventName field containing a command list for operating the designated actuator.

In another general aspect, there is provided A Moving Picture Experts Group (MPEG) terminal including: an OutputActuator node configured to deliver data obtained from a scene to a target actuator by designating the target actuator, generating a command list for operating the target actuator and transmitting the command to the target actuator.

In yet another general aspect, there is provided A method of controlling an actuator using an OutputActuator node, the method including: designating a target actuator to which a command for control is delivered; a generating a command list for operating the target actuator; and storing information about the target actuator and the generated command list in a scene descriptor.

Other features and aspects may be apparent from the following detailed description, the drawings, and the claims.

### BRIEF DESCRIPTION OF THE DRAWINGS

FIGS. 1 and 2 are diagrams illustrating examples of an augmented reality service scenario using an OutputActuator node according to at least one of exemplary embodiments of the present invention.

FIG. 3 is a diagram illustrating a definition of an OutputActuator node and a method of driving actuators using the OutputActuator node.

FIG. 4 is diagram illustrating a Moving Picture Experts Group-4 (MPEG-4) terminal with MPEG-4 BIFS that includes OutputActuator nodes according to an exemplary embodiment of the present invention.

FIG. 5 is a diagram illustrating an example of an MPEG terminal with MPEG-4 BIFS, in which InputSensor nodes interwork with OutputActuator nodes.

FIG. 6 is a diagram illustrating an example of the connection between the InputSensor node and the OutputActuator node shown in FIG. 5.

FIG. 7 is a flowchart illustrating a method for controlling an actuator using an OutputActuator node according to an exemplary embodiment of the present invention.

FIG. 8 is a flowchart illustrating in detail the process of generating the command in 710 shown in FIG. 7.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Exemplary embodiments will now be described more fully hereinafter with reference to the accompanying drawings, in which exemplary embodiments are shown. The present disclosure may, however, be embodied in many different forms and should not be construed as limited to the exemplary embodiments set forth herein. Rather, these exemplary embodiments are provided so that the present disclosure is thorough, and will fully convey the scope of the invention to those skilled in the art.

Throughout the drawings and the detailed description, unless otherwise described, the same drawing reference numerals are understood to refer to the same elements, features, and structures. The relative size and depiction of these elements may be exaggerated for clarity, illustration, and convenience.

An augmented reality (AR) service is an overlay of augmented content on a screen. The AR service may only change objects on the screen during the interaction between a user and the augmented content. If sensory information can be utilized in interaction between the user and augmented content and the change in augmented content can control an actual actuator, it may be possible to provide more realistic AR services to a user. In exemplary embodiments of the present invention, a node capable of controlling an actuator is added to a scene descriptor of Moving Picture Experts Group-4 (MPEG-4), for example, binary format for scenes (BIFS), thereby enabling the control of the actual actuator, and hence the real actuator can be included in a scene configuration in association with the existing scene descriptor.

With respect to MPEG-4 BIFS, a configuration of a screen to be displayed to a viewer is referred to as a scene, which is a new concept that has never been introduced to MPEG-1 and MPEG-2 which only deal with standardized video encoding schemes. On the contrary, MPEG-4 scheme is able to encode a particular object, and deal with a compression-encoded video and also a specific object generated by designating a parameter. In addition, in the MPEG-4 scheme, it is possible to change a scene constituting one MPEG-1 or MPEG-2 video to a scene into which a plurality of objects are combined, and thus an MPEG-4 system may require an element to describe a scene in an effort to specify display methods and properties of objects. The scene refers to one displayed image containing various media objects including a still image, text, a moving picture image, audio, and the like. A scene descriptor is thus required to indicate spatial positions and temporal relationships among these objects. MPEG-4 standardizes the scene descriptor as BIFS.

Basic elements of BIFS are nodes. One group of nodes makes scene description feasible, and each node represents each object in the scene spatially and temporally. The node is assigned properties and environment variables according to an element in the node, which is referred to as a “field.” In addition, the field provides a handle that processes an event, such as a mouse click, in association with a sensor and route node.

In exemplary embodiments of the present invention, there is provided a method for allowing a user to have a realistic experience with an augmented object and interact with the augmented object in an effort to provide a more realistic AR service, without simply overlaying the augmented object on a screen. For example, when a viewer pets a puppy as an augmented object, the viewer should be able to feel the puppy with his/her hand and the augmented puppy may react by wagging its tail. To this end, according to the exemplary embodiments of the present invention, a sensor for detecting a user's location, a method for defining a reaction of an augmented object in accordance with the detected user's location, a method for creating a control command to control a haptic actuator for providing a realistic feeling of petting the puppy, and a method for delivering the control command to the haptic actuator are provided.

Hereinafter, a method and apparatus for controlling an actuator in scene configuration information by adding an OutputActuator node, which controls an actuator, to MPEG-4 BIFS will be described with reference to the accompanying drawings. Further, a method and apparatus for providing augmented reality services that enables five-sense interaction with an augmented object by associating an OutputActuator node with an InputSensor node and controlling the actuator based on sensory information obtained by the sensor.

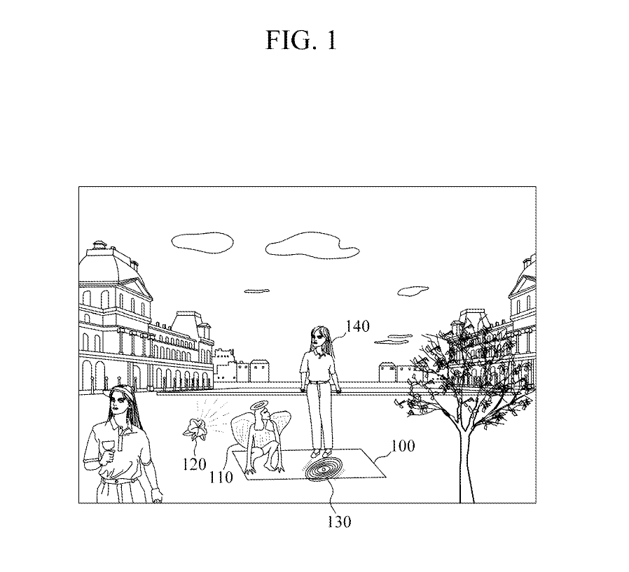

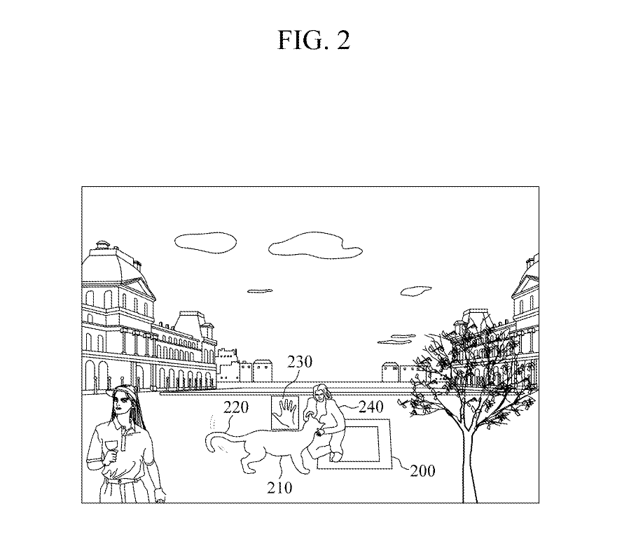

FIGS. 1 and 2 are diagrams illustrating examples of an AR service scenario using an OutputActuator node according to at least one of exemplary embodiments of the present invention.

FIG. 1 illustrates an AR advertising of perfume on an outdoor billboard. Referring to FIG. 1, when a user 140 stands on a footplate 100, an angel 110, i.e., an augmented object, appears on an AR region on a screen, and is hovering around the user 140. At this time, the perfume as an advertised product is sprayed toward the user 140 through a scent type actuator 120 in response to a control command from the OutputActuator node, and the a vibration type actuator 130 vibrates the footplate 100 in response to the control command from the OutputActuator node, so that more effective advertising is possible by providing the user with a vivid sense of reality.

Referring to FIG. 2, when a user 240 is in position on a footplate 200, a leopard 210, i.e., an augmented object, is displayed overlapping an actual image, and when the user 240 strokes the leopard 210, the leopard 210 wags its tail 220, and the user 240 can have a real feeling of stroking that is provided by a haptic type actuator 230 in response to a control command from the OutputActuator node, so that it is possible to provide more effective, realistic advertising.

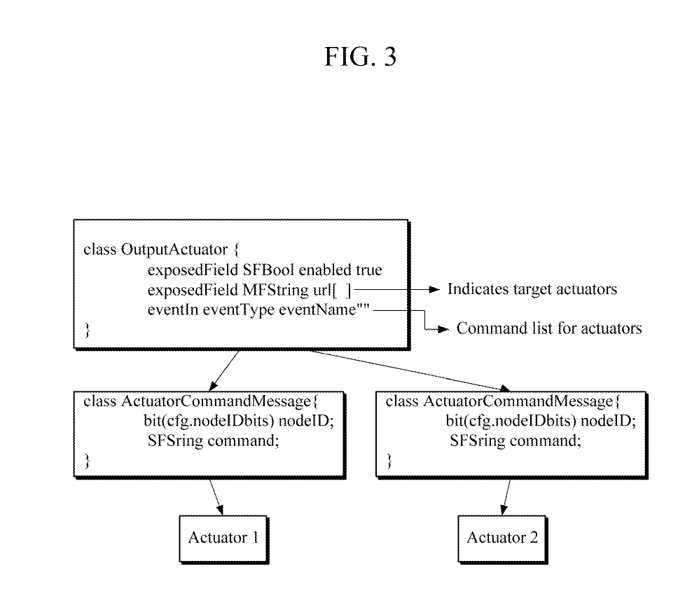

FIG. 3 is a diagram illustrating a definition of OutputActuator node and a method of driving actuators using the OutputActuator node.

Referring to FIG. 3, to realize AR services as shown in FIGS. 1 and 2, OutputActuator node that is equivalent to InputSensor Node of MPEG-4 BIFS is newly added according to an exemplary embodiment of the present invention, and a device data frame (DDF) between the OutputActuator node and an actual actuator device is defined. The OutputActuator node may be defined as shown in Table 1 below.

TABLE 1

EXTERNPROTO OutputActuator [

| exposedField | SFBool | enabled | TRUE |
|---|---|---|---|
| exposedField | MFString | url | [ ] |
| Any number of the following may then follow: | | | |
| eventIn | eventType | eventName | |

]”″org:mpeg:outputactuator″

Each field constituting the OutputActuator node may be described by Table 2 as shown below.

TABLE 2

| Event | Type | Field | Description |
|---|---|---|---|
| exposedField | SFBool | enabled | Represent whether |
| | | | OutputActuator node is |
| | | | activated or deactivated |
| exposedField | MFString | url | Designate a target actuator |
| | | | to which actuator control |
| | | | command is delivered |
| eventIn | eventType | eventName | Contain command list for |
| | | | operating target actuator |

Referring to FIG. 2, the OutputActuator node operates only when having “True” as a value in an enabled field. A url field indicates a target actuator to which a command is delivered. The url field may indicate multiple target actuators. An eventName field contains a command list for operating an actuator. Each command may be mapped with a target actuator described in the url field.

In one example, message standards may be defined as below, in an effort to deliver a command to an actuator.

TABLE 3

ActuatorCommandMessage [

| Bit(cfg.nodeIDbits) nodeID | |
|---|---|
| SFString | command |

]

Referring to FIG. 3, a nodeID field of ActuatorCommandMessage indicates an ID of OutputActuator node, and a command field performs the delivery of the command from the OutputActuator node to the actuator.

Referring to FIG. 3 again, the url field of the OutputActuator node specifies an actuator to which the command is delivered, and the eventName field of the OutputActuator contains a command list for operating the designated actuator. Further, the OutputActuator may transmit each command, through ActuatorCommandMes sage, to a corresponding designated actuator, for example, actuator 1 and actuator 2 shown in FIG. 1.

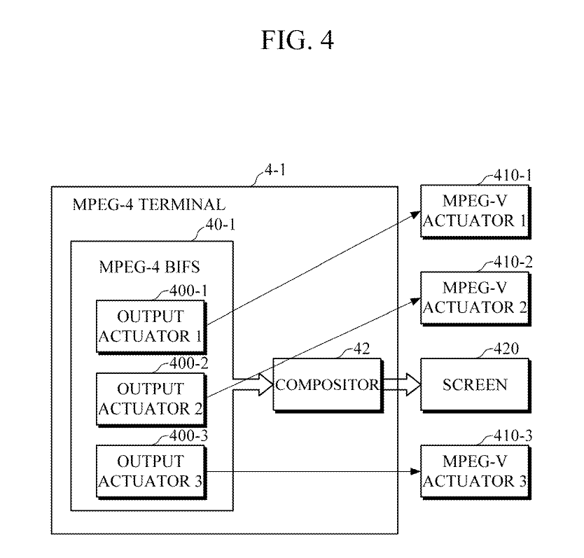

FIG. 4 is diagram illustrating an MPEG-4 terminal 4-1 with MPEG-4 BIFS 40-1 that includes OutputActuator nodes 400-1, 400-2, and 400-3 according to an exemplary embodiment of the present invention.

Referring to FIG. 4, the OutputActuator nodes 400-1, 400-2, and 400-3 are included in MPEG-4 BIFS 40-1 of the MPEG-4 terminal 4-1. The OutputActuator nodes deliver data from a scene to MPEG-V actuators 410-1, 410-2, and 410-3. The OutputActuator nodes determine their target MPEG-V actuator among the MPEG-V actuators 410-1, 410-2, and 410-3, generate a command list of commands for driving the respective target MPEG-V actuators, and transmit each command to the target MPEG-V actuators 410-1, 410-2, and 410-3. For example, as shown in FIG. 4, OutputActuator node 1 400-1, OutputActuator node 2 400-2, and OutputActuator node 3 400-3 transmit a command to MPEG-V actuator 1410-1, MPEG-V actuator 2 410-2, and MPEG-V actuator 3 410-3, respectively.

In response to receiving a plurality of events, the OutputActuator nodes 400-1, 400-2, and 400-3 generate DDFs from the received events and transmit the generated DDFs to the respective MPEG-V actuators 410-1, 410-2, and 410-3. In this case, each of the OutputActuator nodes 400-1, 400-2, and 400-3 may transmit a command in the form of a message to the corresponding MPEG-V actuator 410-1, 410-2, and 410-3, the command including a nodeID field representing an identifier of each OutputActuator Node and a command field for transmission of the command to the target MPEG-V actuator. A compositor 42 combines and arranges media objects on a screen 420 according to the scene descriptor.

In the example shown in FIG. 4, each OutputActuator node 400-1, 400-2, and 400-3 transmits a command to the target MPEG-V actuator 410-1, 410-2, and 410-3, but the aspects of the invention are not limited thereto. For example, one OutputActuator node may transmit a command to multiple MPEG-V actuators.

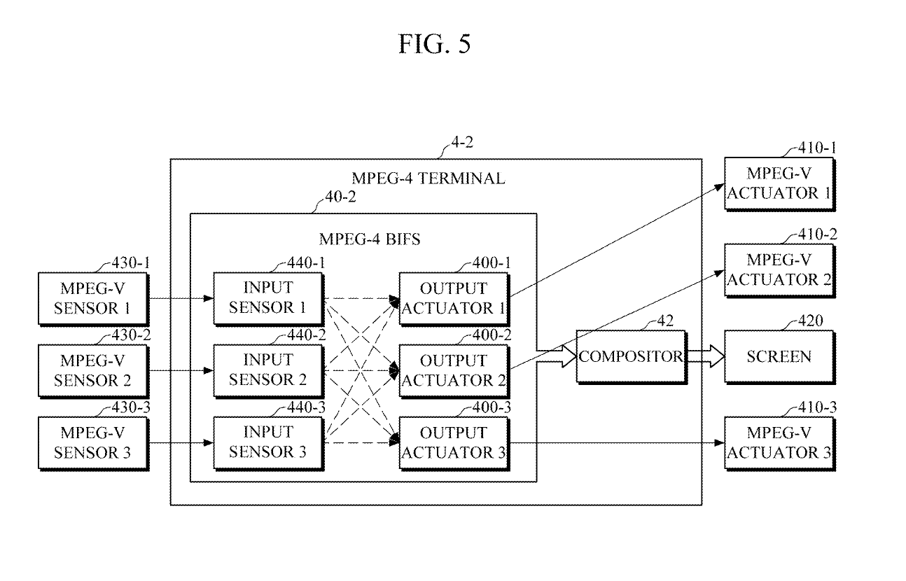

FIG. 5 is a diagram illustrating an example of an MPEG terminal 4-2 with MPEG-4 BIFS 40-2, in which InputSensor nodes 440-1, 440-2, and 440-3 interwork with OutputActuator nodes 400-1, 400-2, and 400-3.

Referring to FIG. 5, each of the InputSensor nodes 440-1, 440-2, and 440-3 receives sensing data in DDF form, which is obtained by each of MPEG-V sensors 430-1, 430-2, and 430-3. InputSensor nodes 440-1, 440-2, and 440-3 generate commands to control the MPEG-V actuators 410-1, 410-2, and 410-3, and deliver BIFS-commands to the OutputActuator nodes 400-1, 400-2, and 400-3 through buffer fields. At this time, data processing may be required to transform the sensing data to a command, and a script node may be utilized for this data processing. In this manner, the commands of the OutputActuator nodes 400-1, 400-2, and 400-3 may be updated, and the updated commands are transmitted to the MPEG-V actuators 410-1, 410-2, and 410-3. The compositor 42 combines and arranges media objects on a screen 420 according to a scene descriptor.

In the example shown in FIG. 5, each OutputActuator node 400-1, 400-2, and 400-3 transmits a command to the target MPEG-V actuator 410-1, 410-2, and 410-3, but the aspects of the invention are not limited thereto. For example, one OutputActuator node may transmit a command to multiple MPEG-V actuators.

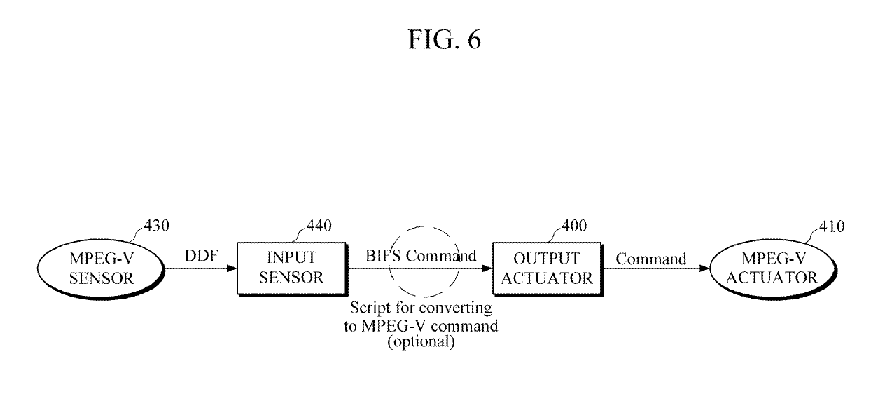

FIG. 6 is a diagram illustrating an example of the connection between the InputSensor node 440 and the OutputActuator node 400 shown in FIG. 5.

Referring to FIG. 6, the MPEG-V sensor 430 transmits sensing data in DDF form to the InputSensor node 440, and the InputSensor node 440 generates a command to control the MPEG-V actuator 410, based on the sensing data, and delivers a BIFS-command to the OutputActuator node 400. In this case, the InputSensor node 440 may transform the sensing data to a command through a script node. In this manner, a command of the OutputActuator node 400 is updated and the updated command is delivered to the MPEG-V actuator 410.

A definition of command standards for each actuator type that ensure the compatibility between BIFS and the actuator may be provided as shown in Table 4 below.

TABLE 4

Light Actuator
The definition of MPEG-V Light Actuator DDF is the following:
MPEGVLightActuatorType [

SFFloat intensity
SFVec3F color

]
The deviceName is “MPEG-V:siv:LightActuatorType”.

Referring to Table 4, a light actuator receives input events from the OutputActuator node, one indicating a light intensity and another indicating a light color.

TABLE 5
Vibration Actuator
The definition of MPEG-V Vibration Actuator DDF is the following:
MPEGVVibrationActuatorType [

SFFloat intensity

]
The deviceName is “MPEG-V:siv:VibrationActuatorType”.

Referring to Table 5, a vibration actuator receives an input event that indicates vibration intensity from the OutputActuator node.

TABLE 6

Tactile Actuator
The definition of MPEG-V Tactile Actuator DDF is the following:
MPEGVTactileActuatorType [

MFFloat intensity

]
The deviceName is “MPEG-V:siv:TactileActuatorType”.

Referring to Table 6, a tactile actuator receives an input event that indicates a tactile intensity from the OutputActuator node. Any addition to the above command standards is possible according to a control parameter of an actuator, with reference to Tables 4 through 6.

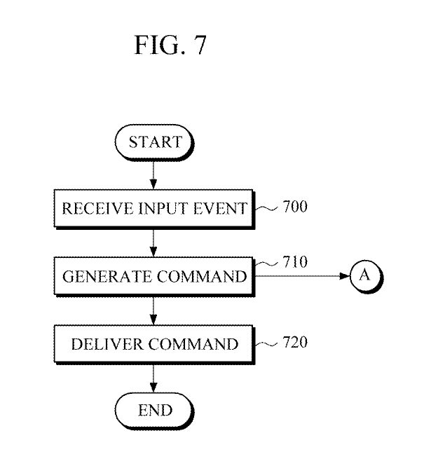

FIG. 7 is a flowchart illustrating a method for controlling an actuator using an OutputActuator node according to an exemplary embodiment of the present invention.

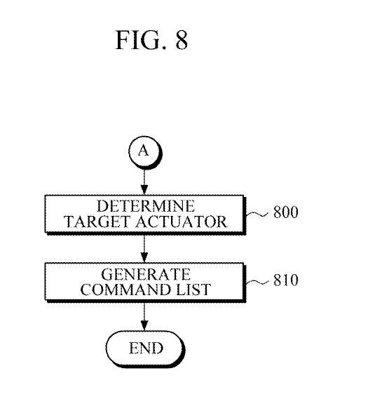

Referring to FIG. 7, after receiving an input event in 700, a command in DDF form is generated from the input event in 710, and the generated command is transmitted to an actuator in 720. The generation of the command in 710 will be described in detail with reference to FIG. 8.

In one example, the OutputActuator node may receive a command from an InputSensor node so as to control the actuator. The command is generated by the InputSensor node that receives sensing information in DDF form from a sensor and transforms the sensing information to the command. The OutputActuator node updates a command list for operating a target actuator in response to receiving the command from the InputSensor node, and delivers the updated command to the actuator.

FIG. 8 is a flowchart illustrating in detail the process of generating the command in 710 shown in FIG. 7.

Referring to FIG. 8, the OutputActuator node determines a target actuator to which to deliver a command for control in 800, and generates a command list for operating the designated actuator in 810.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An OutputActuator node comprising:
an enabled field indicating whether the OutputActuator node is activated or not;
a url field designating an actuator to which a command is delivered for control of the actuator; and
an eventName field containing a command list for operating the designated actuator.

2. The OutputActuator node of claim 1, being included in a Moving Picture Experts Group-4 (MPEG-4) binary format for scenes (BIFS) of an MPEG-4 terminal.

3. The OutputActuator node of claim 1, being configured to:
receive a plurality of event;
generate a device data frame from the received event; and
transmit the generated device data frame to an actuator.

4. The OutputActuator node of claim 3, being configured to generate the device data frame in response to a value in the enabled field being TRUE.

5. The OutputActuator node of claim 1, wherein each command contained in the eventName field is mapped with an actuator designated in the url field.

6. The OutputActuator node of claim 1, further comprising:
an identifier (ID) field identifying the OutputActuator node; and
a command field delivering the command of the OutputActuator node to the designated actuator.

7. A Moving Picture Experts Group (MPEG) terminal comprising:
an OutputActuator node configured to deliver data obtained from a scene to a target actuator by designating the target actuator, generating a command list for operating the target actuator and transmitting the command to the target actuator.

8. The MPEG terminal of claim 7, wherein the OutputActuator node is included in MPEG-4 BIFS of the MPEG terminal.

9. The MPEG terminal of claim 7, wherein the OutputActuator node is configured to generate a device data frame from an event of a plurality of received events, and transmit the generated device data frame to a target actuator.

10. The MPEG terminal of claim 9, wherein the OutputActuator node is configured to transmit a command in a form of a message to a target actuator and the command in the form of message includes a nodeID field indicating an identifier of the OutputActuator node and a command field that delivers a command for operating the actuator.

11. The MEPG terminal of claim 7, further comprising:
an InputSensor node configured to generate a command for controlling the target actuator using sensing data received from a sensor, wherein the OutputActuator node receives the command from the InputSensor node and delivers the received command to the target actuator.

12. The MPEG terminal of claim 11, wherein the InputSensor node is included in an MPEG scene descriptor of the MPEG terminal.

13. The MEPG terminal of claim 11, wherein the sensing data from the sensor is delivered in a form of a device data frame to the InputSensor node.

14. The MPEG terminal of claim 11, further comprising:
a script node configured to transform the sensing data in a form of a command.

15. The MPEG terminal of claim 7, wherein the target actuator is a light actuator and, the light actuator receives input events from the OutputActuator node, one indicating a light intensity and another indicating a light color.

16. The MPEG terminal of claim 7, wherein the target actuator is a vibration actuator and the vibration actuator receives an input event that indicates vibration intensity from the OutputActuator node.

17. The MPEG terminal of claim 7, wherein the target actuator is a tactile actuator and the tactile actuator receives an input event that indicates a tactile intensity from the OutputActuator node.

18. A method of controlling an actuator using an OutputActuator node, the method comprising:
designating a target actuator to which a command for control is delivered;
a generating a command list for operating the target actuator; and
storing information about the target actuator and the generated command list in a scene descriptor.

19. The method of claim 18, further comprising:
receiving an input event; and
generating a command in a form of a device data frame from the received input event is and transmitting the command to the target actuator.

20. The method of claim 19, wherein the receiving of the input event comprises receiving a command for controlling an actuator from an InputSensor node, and the transmitting of the target actuator comprises updating a command list for operating the target actuator, in response to receiving the command from the InputSensor node, and delivering a command in the updated command list to the target actuator.
